(19) United States
(12) Patent Application Publication
(10) Pub. No.: US 2023/0139471 A1
(43) Pub. Date: May 4, 2023

(54) Plug Element for a Remote-Controlled Massage Device

(71) Applicant: AMOR Gummiwaren GmbH, Amstadt (DE)

(72) Inventor: Michael Dills, Arnstadt (DE)

(73) Assignee: AMOR Gummiwaren GmbH, Arnstadt (DE)

(21) Appl. No.: 17/274,047

(22) PCT Filed: Sep. 23, 2019
(86) PCT No.: PCT/EP2019/075567

§ 371 Date: Mar. 5, 2021

(30) Foreign Application Priority Data
Sep. 25, 2018 (EP) 18196 656.5

(51) Int. Cl. A61H 23/02; H01R 13/52; A61H 19/00; A61H 23/00

(52) U.S. Cl. CPC A61H 23/02; H01R 13/5208; H01R 13/5224; A61H 19/00; A61H 23/008; H01R 2201/12; A61H 2201/1676; A61H 2201/0111

(57) ABSTRACT

A plug element for connecting a massage device to an energy source which includes a housing having two charging electrodes for connecting to an energy source, a control unit, a wireless data communications device, and a PCB antenna for transmitting and receiving radio signals of the wireless data communications device. The plug element also includes a cable emerging from the housing for connecting the plug element to the massage device. The plug element is provided at a first end of the cable and the opposing second end of the cable is configured for connecting to a massage device. The housing, the cable, and the connection between the housing and the cable are configured to be liquid-proof.

### CROSS-REFERENCE TO RELATED APPLICATION

The present application is a U.S. national phase entry of pending International Patent Application No. PCT/EP2019/075567, international filing date Sep. 23, 2019, which claims priority to European Patent Application No. EP 18 196 656.5, filed Sep. 25, 2018 the contents of which are incorporated by reference in their entireties.

### FIELD OF THE INVENTION

The invention relates to a plug element for connecting a massage device for massaging body parts, especially the genitals, to an energy source.

Massage devices of the type indicated above are also known as vibrators, of which there are many different shapes and sizes. Among them are battery-operated vibrators with direct control or control via a cable and vibrators with remote control, e.g., via the Bluetooth protocol. A massage device for intimate stimulation is known from WO 02/38100 A2, for example, in which a cable or a cord, which serves as an antenna and/or charging cable, is provided at one end of the massager body. Among the disadvantages of the known massage devices, however, is that the bushing at the free end of the return cord is not liquid-tight. Liquid can therefore penetrate into the opening of the bushing, and this can lead to the corrosion and thus to the malfunction of the device. Because of the dimensions of the cable, furthermore, configuring the charging cable as an antenna indicates that there is a limitation to certain frequencies and types of antennas. In particular, it is thus not possible to use current mobile data communications standards such as, for example, Bluetooth, IEEE 802.11 (WIFI), GSM, UMTS, LTE, 5G, and the like for wireless communication between a remote (operating) device such as a smartphone and the massage device. A massage device which is connected to a plug by a cable is known from EP 3 299 005 A1, wherein the plug comprises charging electrodes for charging an energy storage unit of the massage device and a PCB antenna for data communications.

### OBJECTS OF THE INVENTION

It is an object of the present invention to at least partially overcome the above-cited disadvantages and to provide a massage device which is liquid-proof and thus functions reliably, and which has a simple structure, is sturdy, and can be produced at low cost.

### SUMMARY OF THE INVENTION

According to an aspect of the invention, a plug element for connecting a massage device to an energy source is provided, wherein the plug element comprises a housing having two charging electrodes for establishing the connection to an energy source, and holding a control device, a wireless data communications device, and a PCB antenna for transmitting and receiving radio signals of the wireless data communications device. The plug element also comprises a cable, which emerges from the housing to connect the plug element to the massage device, wherein the plug element is provided at a first end of the cable, wherein the opposing second end of the cable is configured to connect to the massage device. The housing, the cable, and the connection between the housing and the cable are configured to be liquid-proof.

In this way, a first goal is achieved that the penetration of liquid into the plug element and thus into the area of the sensitive electrical components of the massage device is avoided. The components installed in the housing of the plug element are protected from liquid, and the reliability of their operation is guaranteed. Arranging the PCB antenna in the plug element guarantees reliable communications between the wireless data communications device and a remote (operating) device or radio cell base station, because the plug element, when the massage device is being used as intended, is always located outside the body. Because the wireless data communications device and the PCB antenna are both installed in the housing, it is also possible to prevent the massage device from malfunctioning as a result of interference with the received signals during the transmission of signals between the PCB antenna and the data communications device. In particular, the high-frequency antenna signal is subjected to the least possible amount of interference, and the effects exerted by the flow of current associated with the USB charging voltage source (DC voltage) are minimized. PCB antennas, furthermore, are also able to transmit and to receive signals according to current data transmission standards. In addition, all of the components of the massage device important for the control function are arranged in the plug element, as a result of which, first, a compact and simple structure is obtained, and, second, low-cost production is facilitated. In particular, the structure of the massager part or vibratory body of the massage device can be simplified considerably, because this part need only contain a vibration-generating device and an energy-storage unit, whereas other electrical components, in particular the sensitive electronic components, can be moved out into the plug element. Because the plug element is independent of the vibratory body, the plug element can be used for many vibratory bodies of different configurations, as a result of which the production costs can be further reduced. Finally, because of their liquid-proof configuration, not only the vibratory body of the massage device, which is introduced into a body cavity, but also the cable and the plug element satisfy the hygiene regulations applicable to devices of this type, such as EP67 (DIN EN 60528). The cable and the plug element, furthermore, can therefore be cleaned easily and offer no openings into which liquid can penetrate in such a way as to impair the function of the massage device.

According to another aspect of the invention the plug element may be formed flat and the charging electrodes may be USB-compatible. With USB technology, it is possible to use a very widely-used method to charge the energy-storage unit of the massage device or also to transmit data. The flat plug element comprises a configuration similar to that of a USB-A plug, which can be inserted into a corresponding USB port. Connecting ports of this type are present on a large number of different devices such as PCs, laptops, notebooks, tablet computers, power devices, and the like, and make available sufficient charging current according to the USB standard (up to 500 mA at 5V according to USB 2.0). In addition, the plug element can therefore be made much smaller than conventional power grid plugs. Because of the low power uptake and the low voltage, handling the USB-compatible plug element poses no danger to the operator, in contrast to the situation with a conventional 220 V power plug.

According to another aspect of the invention, the housing may comprise a length, a width, and a height, wherein the length is greater than the width, and the ratio of length to height is less than 10:1, preferably less than 8:1, and even more preferably less than or equal to 6:1, and wherein the ratio of length to width is less than 10:1, preferably less than 7:1, and even more preferably less than or equal to 3:1. The housing may have a size of no more than 50 mm×30 mm×20 mm, more preferably no more than 40 mm×20 mm×10 mm, and even more preferably of no more than 35 mm×15 mm×6 mm. The plug element is therefore relatively small, which means that, when the associated massage device is being used, the plug element is not perceived as cumbersome, and the handling of the massage device is not negatively affected. At the same time, the plug element is easy to grip and can be handled ergonomically.

According to another aspect of the invention, the plug element may also comprise an actuating element, which is formed in a top surface of the plug element. The actuating element may be used to actuate the massage device directly by way of the control unit as a supplement to remote-controlled operation and thus makes it possible to use the massage device even without a remote control device. The actuating or operating element can, for example, be configured as a pressure element on the surface of the housing of the plug element and is therefore readily accessible and can be operated easily even when the massage device is being used. Alternatively or in addition, it is possible to equip the actuating or operating element with a touch-sensitive operating surface, which can be operated by touching it with a finger as in the case of a smartphone.

According to another aspect of the invention, the housing of the plug element may also comprise a gripping area on its surface. The gripping area may be formed near the end of the plug element at which the cable is attached to the plug element. This makes it easy to plug the element it in or to pull it out of the charging port. The gripping area can be formed by grooving or by a convexity of the surface of the plug element. Other effective configurations which do not affect the function of the plug element or of the antenna element are also possible. In particular, the operating element can be formed as the gripping area to ensure good haptic properties and ease of operation. Alternatively, the gripping area could also be arranged on a surface opposite the actuating element or on a surface on one side of the actuating element so as to prevent the massage device from being actuated unintentionally.

According to a further aspect of the invention, the charging electrodes, the PCB antenna, the wireless data communications device, and the control unit may be arranged on a common circuit board. The PCB antenna (printed circuit board antenna) may be configured in such a way, for example, that it can be applied at low cost as a metal layer of the appropriate shape, especially a copper layer, to a conventional circuit board. As a result, a compact component can be obtained, and thus space can be saved and costs reduced. In addition, all of the electronic components of the massage device requiring a circuit board may be arranged in the plug element on a common circuit board, which reduces the manufacturing work, production costs, and the complexity of the entire massage device through a reduction in the number of individual parts. No other components of the massage device dependent on a circuit board are required.

According to another aspect of the invention, an especially simple structure may obtained by arranging the charging electrodes, the PCB antenna, the data communications device, and the control unit on the same side of the circuit board. As a result, the height of the structure in particular can be reduced. Alternatively, the charging electrodes, the PCB antenna, the data communications device, and the control unit can be distributed in any desired combination on two opposite sides of the circuit board. Thus, although the height of the structure is increased, the area required for the circuit board is nevertheless decreased. Through skillful arrangement of the components on the circuit board, an efficient and space-saving structure can be achieved. It is also possible to arrange charging electrodes on both sides of the card or circuit board, so that the plug element can be plugged into a USB port or corresponding other charging port regardless of orientation (in either orientation) in user-friendly fashion. In this case, a logic circuit is needed in the control unit to recognize the positive pole and the negative pole as appropriate.

According to another aspect of the invention, the PCB antenna and the data communications device may be configured to transmit and to receive radio signals according to the Bluetooth protocol (per IEEE 802.15.1), ZigBee (per IEEE 802.15.4), ANT, NFC (Near Field Communication), WIFI (per IEEE 802.11), GSM, UTMS, LTE, 5G, or some other mobile data transmission standard. This makes it possible in particular to transmit and to receive radio signals with the required reliability and speed from a plurality of different remote operating devices, especially from smartphones and computers. If the PCB antenna and the data communications device are set up for communication by 5G, this offers the special advantage that the massage device does not necessarily have to be connected to a smartphone for remote operation. Instead, the plug element or massage device can communicate directly with a base station of a radio cell or a mobile radio network. The massage device can then also be actuated or operated directly from great distances or can communicate directly with other devices. The plug element can comprises a SIM card, which assigns a unique ID to the plug element or massage device and logs into the mobile radio network, preferably automatically, when the massage device is in use. The SIM card can be configured as a physical SIM card or as an embedded SIM (eSIM). If the plug element or the massage device can be uniquely identified, it can also be set for IoT (Internet of Things) applications.

According to another aspect of the invention the cable may comprise two strands. The cable may connect the plug element to a vibratory body of the massage device and therefore serves to transfer current during the charging of the massaging device and to transmit the signals for controlling or actuating the massaging device. It is preferred that the two strands be separated from each other and for each one to be waterproof. As a result, the transmitted signals are not undesirably influenced or subjected to interference, and each of the lines is reliably protected from the intrusion of liquid.

According to a further aspect of the invention one of the strands may comprise at least one electrical line for connecting the charging electrodes to an energy storage unit of the massage device and that the other strand comprise a signal line for connecting the control unit to a vibration-generating device of the massaging device.

According to another aspect of the invention, the housing may be made of a biocompatible plastic or comprises a casing of a biocompatible plastic. The cable may also comprise a sheathing of a biocompatible plastic. As a result, the components such as the circuit board, the PCB antenna, the data communications device, and the control unit as well as the points where these components are connected to the cable strands are protected from corrosion, for example. In addition, it is guaranteed that the plug is appropriate for use with a massaging device on and in the human body.

According to another aspect of the invention, the housing may be fabricated by injection-molding or for the biocompatible plastic casing to be applied by injection-molding. Thus, an integrally configured plug is obtained, which offers the least possible surface area subject to impairment or manipulation from the outside.

According to a further aspect of the invention, the material of the plastic or of the plastic casing may be a thermoplastic material such as an acrylonitrile-butadiene-styrene copolymer (ABS) or a comparable plastic with similar properties. These thermoplastics are insensitive to standard commercial lubricants and cleaning agents and are also neutral with respect to taste and odor.

According to another aspect of the invention, the charging contacts of the plug element may comprise a plating with a metal or a metal alloy in the form of, for example, a plating with gold or a gold alloy or in the form of a surface treatment with some other metal or metal alloy. In particular, it is important to prevent the charging contacts from corroding and to guarantee the reliable transfer of current.

According to another aspect of the invention, a remote-controlled massaging device capable of massaging body parts, especially the genitals, may comprise, a plug element, which, as previously described, comprises a vibratory body encompassing a vibration-generating device and an energy storage unit, wherein the vibratory body is connected to the plug element only by the cable.

Thus a massaging device is provided which is especially easy to handle and which can be produced at low cost. In particular, only the vibration-generating device and the energy storage unit, which occupy a relatively large amount of space, need to be provided in the vibratory body, whereas all the other components, i.e., the electronic ones, are moved out into the plug element. The vibratory body itself is therefore lighter and easier to handle. Because of the smaller number of components to be accommodated in the vibratory body, the external design, especially the size and contour of the vibratory body, is less predetermined by the components to be housed in it; on the contrary, its contours can be adapted more flexibly to different requirements and areas of application. Because the plug element can be used for a large number of different massaging devices, the low manufacturing costs associated with the larger achievable manufacturing runs have an advantageous effect on the cost of the massaging device.

In embodiments, the vibratory body may be made of silicone, TPE, or some other appropriate thermoplastic material. These materials are safe from a hygienic standpoint and have pleasant and thus especially appropriate haptic properties, which are well adapted to use on or in the body. The material of the massaging device is preferably UV-proof and odor and taste-neutral, wherein it is also possible to use different colors.

In especially preferred embodiments, the vibratory body may be configured as a shockwave vibrator or as an oscillating vibrator. In principle, the plug element according to the invention can be used with any standard type of vibrator.

In embodiments, the vibratory body may be configured without any circuit boards. As a result, it is guaranteed that all of the circuit board-dependent components can be shifted into the plug element, as a result of which the structure becomes simpler and can be manufactured more cheaply.

In particular, it is possible for the entire control system of the massage device to be arranged in the plug element.

### BRIEF DESCRIPTION OF THE DRAWINGS

FIG. 1 shows a perspective view of a preferred embodiment of the plug element according to the invention;

FIG. 2a shows a perspective view of a preferred embodiment of the circuit board of the plug element according to FIG. 1, from underneath;

FIG. 2b shows a perspective view of the circuit board of FIG. 2a from above;

FIG. 3 shows a perspective view of a preferred embodiment of the housing of the plug element according to FIG. 1;

FIG. 4 shows a perspective view of a preferred embodiment of the actuating element of the plug element according to FIG. 1; and

FIG. 5 shows a perspective view of a preferred embodiment of the massage device according to the invention.

### DETAILED DESCRIPTION OF SPECIFIC EMBODIMENTS

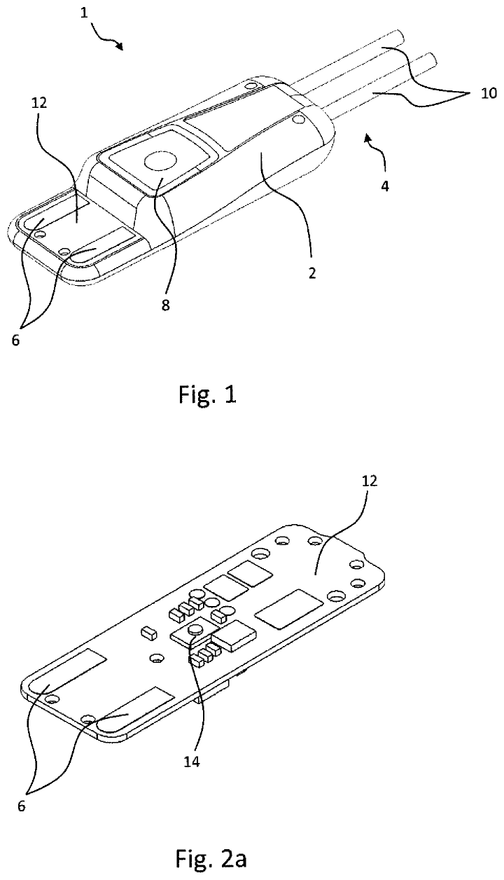

FIG. 1 shows a perspective view of one embodiment of the plug element 1 according to the invention for connecting a massage device, especially a vibrator, to an energy source such as a USB port.

Plug element 1 is configured as a flat plug and comprises a housing 2 and a cable 4. Cable 4 emerges from housing 2 and connects plug element 1 to a vibratory body (not shown), as can be seen in FIG. 5. On its top surface 2, plug element 1 comprises charging electrodes 6, arranged in the longitudinal direction of plug element 1 parallel to each other and being compatible with a USB-A connection. In the preferred embodiment of plug element 1 shown here, the element also comprises an actuating element 8 for actuating the massage device.

In place of actuating element 8 or in addition to the actuating element, a gripping area can be provided on a surface of housing 2, which, for example, is shaped as a convexity. The gripping area serves to make easier to handle plug element 1 as it is being inserted into a corresponding USB port or when pulling it out again. The gripping area is configured so that plug element 1 can be easily gripped and so that it has good haptic properties. For this purpose, the gripping area can, for example, be grooved or have a projection, which the user can easily grasp. As an option, the gripping area can also extend onto the lateral surfaces of the housing, including the edges or corners.

As can also be seen in FIG. 1, cable 4, in the preferred embodiment, comprises two strands 10, which are separated from each other and extend between plug element 1 and the vibratory body. It is conceivable that each of the two strands 10 could emerge from its own opening in housing 2; it is also possible that cable 4 could comprise only one strand in the area of housing 2, which strand then divides into two strands 10 after emerging from housing 2. In this case, the effort required to seal the connection between cable 4 and housing 2 is reduced. It is obviously also possible that the cable 4 could comprise a single strand over its entire length, and that this single strand could accommodate, inside a sheath, all of the lines extending between plug element 1 and the vibratory body.

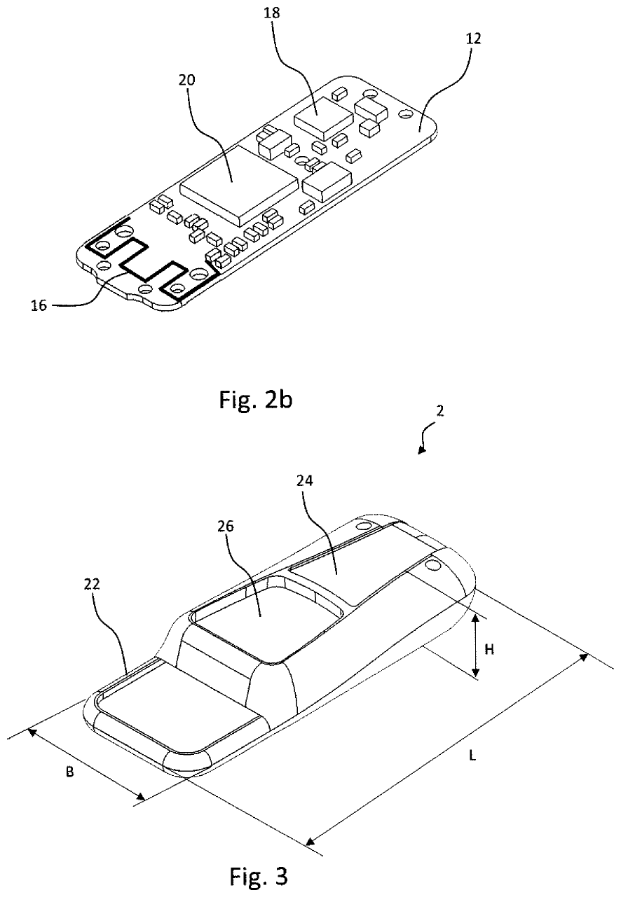

The individual components of plug element 1 according to the invention are described in greater detail below with reference to FIGS. 2 to 4.

Plug element 1 according to the invention comprises a control unit, a wireless data communications device, and a PCB antenna for transmitting and receiving the radio signals of the wireless communications device, all these being installed in housing 2 and preferably arranged on a common circuit board.

FIG. 2a shows a schematic, perspective view of a circuit board 12, on which various components are mounted and connected to each other. In FIG. 2a, it is the bottom surface of circuit board 12 which can be seen. Two charging electrodes 6 are mounted on circuit board 12 so that they extend in the longitudinal direction, parallel to each other. The dimensions, i.e., in particular the spacing between charging electrodes 6 and their length, are calculated so that plug element 1 can be plugged into a corresponding USB port for charging the massage device. Charging electrodes 6 are brought into contact with the connecting ends of the two cable strands 10 (not shown in FIG. 2a or 2b) in the known manner, preferably in corresponding recesses in circuit board 12. In the preferred embodiment, in which cable 4 is configured with two strands 10, the first strand is a simple cable with a litz wire, the end of which is connected to the positive charging electrode. The second strand 10 of cable 4 is configured as a coaxial cable, wherein the external conductor is connected to charging electrode 6 serving as ground.

On the bottom surface of circuit board 12, furthermore, an actuating switch 14 is arranged, which, in the assembled state of plug element 1 according to FIG. 1, is adjacent to an actuating section of actuating element 8. When the user presses actuating element 8, actuating switch 14 is actuated.

FIG. 2b shows a schematic, perspective view of the top surface of circuit board 12, wherein the PCB antenna 16 has been applied as a conductive layer to circuit board 12 by the known technology. A PCB antenna 16 of this type is characterized by a compact structure. In the invention, it is advantageous for PCB antenna 16 to be located in plug element 1 a certain distance away from the printed circuit and the components of the wireless data communications device, because this has the effect of reducing the secondary excitations and the interference attributable to the high-frequency properties of PCB antenna 16.

The shape of the printed circuit-board antenna track(s) of PCB antenna 16 is optimized for good radiating characteristics, high efficiency in reception and transmission, and adequate bandwidth. It is obvious that PCB antenna 16 in FIG. 2b is indicated only schematically and can be arranged and printed on circuit board 12 in a manner familiar to the skilled person in such a way as to meet the given requirements.

Data communications device 18 and control unit 20 are also arranged on circuit board 12; they are connected to the conductive tracks printed on circuit board 12 in the known manner. Data communications device 18 converts the signals received by PCB antenna 16 and makes these available to control unit 20. Control unit 20 in turn controls the vibration-generating device of the massage device according to the received commands. Control unit 20 and wireless data communications device 18 are supplied with power from the energy storage unit of the massage device, whereas, for control purposes, they are supplied with appropriate radio signals by a remote operating device such as a smartphone, a PC, or a similar mobile operating platform.

Control unit 20 can also have a data storage device for storing program runs, as a result of which it is possible to program the massage device with internally or externally prepared vibration programs, to store the vibration programs, and to control the massage device accordingly. In this case, the control signals are supplied by the data storage device. Direct control via the remote operating device is also possible. Additional direct control via the actuating element 8 is an additional possibility.

In a corresponding manner, control unit 20 is connected by conductive tracks printed onto circuit board 12 both to actuating switch 14 and to data communications device 18. A control signal sent by control unit 20 is transmitted by a conductive track printed on circuit board 12 to one of strands 10 and to a vibration-generating device of the massage device. Data communications device 18 is connected via printed conductive tracks at least to PCB antenna 16. In the previously described embodiment, control unit 20 is connected electrically to the coaxial strand; it can be connected, for example, to the inner conductor of the coaxial cable, also called the core. It is also possible to produce the electrical connections described here by adhesive bonding or by some other appropriate contact-establishing technique.

The structure of circuit board 12 with the components mounted on it makes it possible to use standard commercial, mass-produced components, which means that costs can be reduced. Through the concentration of the components conventionally mounted on circuit boards in plug element 1, furthermore, the need for additional circuit boards in the vibratory body is eliminated.

FIG. 3 shows a perspective view of housing 2. Housing 2 is preferably produced by injection molding and ideally injected directly onto circuit board 12. Housing 2 comprises a flat section 22, in the top surface of which an opening is provided, which exposes at least charging electrodes 6 on circuit board 12 to such an extent that contact with an energy source is possible. Flat section 22 of housing 2, including circuit board 12 contained there, is configured in such a way that it can be inserted into conventional USB ports. To provide sufficient space for the other components mounted on circuit board 12, housing 2 adjacent to flat section 22 can have larger dimensions.

Housing 2 is preferably produced by injection-molding it onto circuit board 12 and consists of a thermoplastic material such as acrylonitrile-butadiene-styrene (ABS). Alternatively, housing 2 can be surrounded by an appropriate casing of injected thermoplastic material. Both variants make it possible to provide a housing which is a sealed and thus as liquid-proof as possible, namely, a housing which accommodates the electronic components securely, wherein only charging electrodes 6 are exposed, apart from which a sufficiently effective seal is created.

Housing 2 has a length L, a width B, and a height H, wherein the length is greater than the width. Preferably the ratio of length to height is less than 10:1, preferably less than 8:1, and even more preferably less than or equal to 6:1. It is also preferred that the ratio of length to width be less than 10:1, preferably less than 7:1, and even more preferably less than or equal to 3:1. For example, housing 2 has a size of no more than 50 mm×30 mm×20 mm, more preferably of no more than 40 mm×20 mm×10 mm, and even more preferably of no more than 35 mm×15 mm×6 mm.

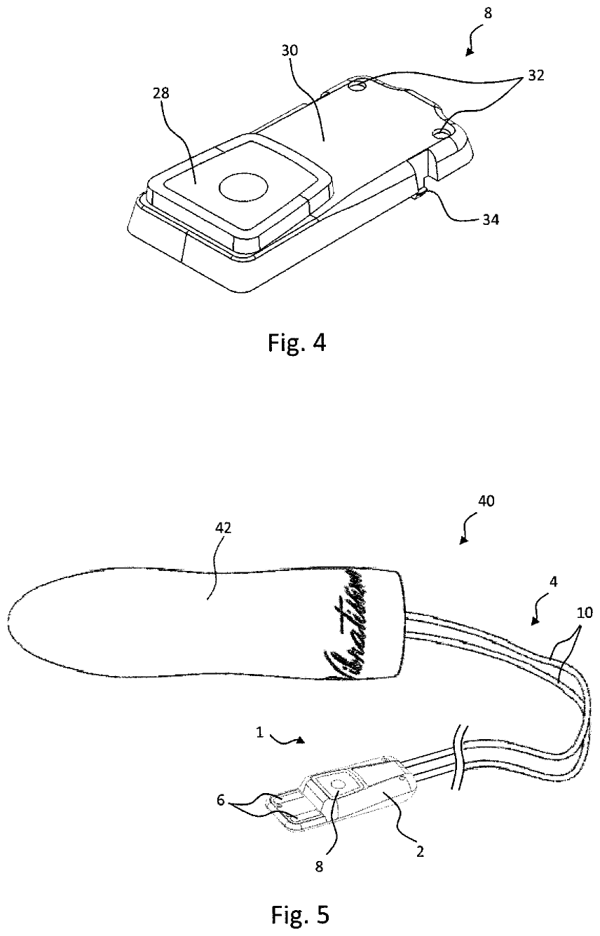

On top surface 24 of housing 2, an additional opening 26 can be provided, which defines a contact area for actuating element 8. Actuating element 8 is described in more detail with reference to FIG. 4 and preferably is mounted on circuit board 12 before the surrounding housing 2 is applied.

Actuating element 8 according to FIG. 4 preferably consists, at least to some extent, of a flexible plastic. Actuating element 8 comprises a contact area 28, which is raised above body 30 of actuating element 8. A surface of body 30 preferably rests in a positive-locking manner against the inside surface of housing 2, and contact area 28 is preferably flush with top surface 28 of housing 2. It can also be desirable, however, for contact area 28 of actuating element 8 to extend beyond top surface 26 of housing 2, so that it stands out from that surface. This makes it possible to actuate the device reliably even when plug element 1 cannot be seen by the user. Contact surface 28, however, can also be configured, especially elevations, as indicated in FIG. 4 by the circular section on contact surface 28, to signal haptically to the user the location of the optimum point to which pressure is to be applied to actuate actuating element 8. On the bottom surface of contact surface 28, actuating element 8 is configured in such a way that, when pressure is applied to contact surface 28, it actuates actuating switch 14 on the circuit board. For this purpose, it is possible, for example, to provide a projection on actuating element 8. For the rest, actuating element 8 is configured so as to allow reliable mounting in housing 2 and comprises, for example, openings 32 or latching elements 34 so that it can be connected to circuit board 12 and housing 2.

FIG. 5 shows a perspective view of a preferred embodiment of massage device 40 according to the invention. Massage device 40 comprises a massage part or vibratory body 42, which is connected to a plug element 1, which has been described with reference to FIGS. 1-4. Cable 4 extends between housing 2 of plug element 1 and vibratory body 42, wherein each of the exit points of cable 4 from housing 2 and from vibratory body 42 is configured to be liquid-proof This can be done by appropriate seals or in that cable 4 comprises a sheathing in common with the adjacent areas of housing 2 and of vibratory body 42. The ends of cable 4 can also be bonded adhesively to housing 2 and to vibratory body 42, wherein the adhesive provides the sealing action in the exit areas of the cable 4.

Vibratory body 42 comprises an oscillation-generating device and an energy storage unit, which are functionally coupled, i.e., electrically connected, to each other, as is basic knowledge familiar to the skilled person. The oscillation-generating device and the energy storage unit can be permanently mounted in vibratory body 42, e.g., overmolded by vibratory body 42 or embedded in it. The oscillation-generating device and the energy storage unit, however, can also be configured so that they can be removed from vibratory body 42. For this purpose, they are to be supported in a mounting holder, which can be inserted into a corresponding opening in vibratory body 42 and removed from it again. Care must be taken to ensure an effective seal between the holder and vibratory body 42. The vibrations generated by the oscillation-generating device are transmitted to the holder and from this to the vibratory body.

The oscillation-generating device comprises, for example, an electric motor with an imbalance weight seated eccentrically on a shaft; this weight causes vibratory body 42 to oscillate in response to signals from control unit 20. The energy storage unit is preferably a rechargeable storage unit such as a battery.

In the embodiment according to the invention, it is now sufficient for vibratory body 42 to hold only the oscillation-generating device and the energy storage unit. The other components, namely, control unit 20, data communications device 18, PCB antenna 12, and charging electrodes 6 are arranged in plug element 1. Because fewer components need to be mounted in vibratory body 42, its shape can be designed with greater freedom and flexibility, and it can be adapted more readily to the user's requirements. In addition, it has the effect of reducing production costs, because all of the components which need to be mounted on a circuit board are mounted on same circuit board 12, which is accommodated in housing 2 and thus, protected.

It is obvious that massage device 40 shown in FIG. 5 is merely an example, and that the size relationship between vibratory body 42 and plug element 1 is not necessarily true to scale. The length of cable 4 can be made shorter or longer, depending on the design of the vibratory body, which depends on turn on whether or not vibratory body 42, when in use, is to be accommodated completely within the body of the user.

The shape of vibratory body 42 can vary considerably, which means that it can fulfill the various wishes of customers for sex toys as completely as possible. Examples of shapes of this type are conventional female vibrator shapes in various lengths and thicknesses, with or without a laterally attached clitoris stimulator; smaller vibratory adaptors; ring-shaped adaptors; vibrator pairs; male vibrators; penis-ring adaptors; anal adaptors; love balls; and the like. The vibratory body can also be configured as a shockwave vibrator. In principle, plug element 1 can be used with any type of vibrator.

With the subject matter according to the invention, a plug element for a remote-controlled massage device and a massage device of this type are provided, which can be produced at low cost, which guarantee reliable, liquid-proof functioning, the energy storage unit of which can be easily charged, and which make possible flexible control by up-to-date wireless data transmission technologies.

1-14. (canceled)

15. Plug element for connecting a massage device to an energy source, wherein the plug element comprises:
a housing having two charging electrodes for connecting to an energy source and holding a PCB antenna for transmitting and receiving radio signals of a wireless data communications device; and
a cable emerging from the housing to connect the plug element to the massage device, wherein the plug element is provided at a first end of the cable and wherein an opposing second end of the cable is configured for connecting to the massage device;
wherein the housing, the cable, and the connection between the housing and the cable are configured to be liquid-proof; and wherein the housing further holds a control unit and the wireless communications device.

16. The plug element of claim 15 wherein the plug element is flat, and in that the charging electrodes are configured to be USB-compatible.

17. The plug element of claim 15 wherein the housing has a length (L), a width (B), and a height (H), wherein the length (L) is greater than the width (B), and in that the ratio of the length (L) to the height (H) is less than 10:1, preferably less than 8:1, and even more preferably less than or equal to 6:1, and wherein the ratio of the length (L) to the width (B) is less than 10:1, preferably less than 7:1, and even more preferably less than or equal to 3:1.

18. The plug element of claim 15 wherein the housing has a size of no more than 50 mm×30 mm×20 mm (L×B×H), preferably of no more than 40 mm×20 mm×10 mm (L×B×H), and even more preferably of no more than 35 mm×15 mm×6 mm (L×B×H).

19. The plug element of claim 15 wherein the plug element also comprises an actuating element, which is formed in a surface of the plug element.

20. The plug element of claim 15 wherein the charging electrodes, the PCB antenna, the wireless communications device, and the control unit are mounted on a circuit board.

21. The plug element of claim 20 wherein the charging electrodes, the PCB antenna, the data communications device, and the control unit are arranged on one side of the circuit board or alternatively are distributed in any desired combination over two opposite sides of the circuit board.

22. The plug element of claim 15 wherein the cable comprises two strands, which are preferably separate from each other and each of which is configured to be waterproof.

23. The plug element of claim 22 wherein one of the strands comprises at least one electrical line for connecting the charging electrodes to an energy storage unit of the massage device, and in that the other strand comprises a signal line for connecting the control unit to an oscillation-generating device of the massage device.

24. The plug element of claim 15 wherein the housing is formed out of a biocompatible plastic or comprises a casing of a biocompatible plastic.

25. Remote-controlled massage device configured for massaging body parts having a plug element according to claim 15 and further including a vibratory body with an oscillation-generating device and an energy storage unit, wherein the vibratory body is connected to the plug element only by the cable.

26. The massage device of claim 25 wherein the vibratory body is a shockwave vibrator or an oscillating vibrator.

27. The massage device of claim 25 wherein the vibratory body is configured to be free of circuit boards.

28. The massage device of claim 25 wherein the entire control system of the massage device is arranged in the plug element.
